(19) United States
(12) Patent Application Publication
(10) Pub. No.: US 2020/0124307 A1
(43) Pub. Date: Apr. 23, 2020

(54) CONTROL APPARATUS AND COMPUTER READABLE MEDIUM

(71) Applicant: MITSUBISHI ELECTRIC CORPORATION, Tokyo (JP)

(72) Inventors: Yoshihiro OTA, Tokyo (JP); Tomooki UKIANA, Tokyo (JP)

(73) Assignee: MITSUBISHI ELECTRIC CORPORATION, Tokyo (JP)

(21) Appl. No.: 16/067,527

(22) PCT Filed: Feb. 24, 2016
(86) PCT No.: PCT/JP2016/055491

§ 371 Date: Jun. 29, 2018

(51) Int. Cl. F24F 11/46; G05B 19/042; F24F 11/64; F24F 11/65

(52) U.S. Cl. CPC F24F 11/46; G05B 19/042; F24F 2110/10; F24F 11/65; G05B 2219/2614; F24F 11/64

(57) ABSTRACT

A control apparatus (20) calculates a plurality of Pareto optimal solutions indicating states wherein power consumption consumed by an air conditioning system (10) including a plurality of air conditioners (40A, 40B) installed in spaces (50A, 50B) is low, and wherein comfort levels of users using the spaces (50A, 50B) respectively are high, and takes, as candidate values, set values of the air conditioning system (10) to become the states indicated respectively by the plurality of Pareto optimal solutions calculated. The control apparatus (20) makes a management device (30) control the air conditioning system (10) with a selection value selected from the candidate values calculated.

### TECHNICAL FIELD

The present invention relates to a technique to control an air conditioning system including a plurality of air conditioners installed in a plurality of spaces.

### BACKGROUND ART

In buildings and factories, etc., electric power is controlled so as not to exceed a maximum demand electric power in accordance with a demand contract. In business offices, etc., it is important to control an air conditioning system in order not to exceed a maximum demand electric power by suppressing power consumption of an air conditioning system that accounts for a large percentage in the power consumption.

Meanwhile, there is a possibility that only by control of suppressing power consumption, a comfort level for a user in a space where an air conditioner is installed may be impaired. Therefore, it is desired to realize control over an air conditioning system wherein power consumption is suppressed as much as possible while maintaining the comfort level in the space.

Especially, in buildings and factories, etc., there are a plurality of spaces wherein air conditioners are installed, and intended use and priority of respective spaces are different. Thus, it is necessary to control air conditioners so as to suppress the power consumption in overall premises or buildings while adjusting how much comfort levels are maintained in respective spaces.

Patent Literature 1 discloses control over an air conditioning system using an optimum operation function. In Patent Literature 1, an optimum operation functions is generated offline by calculating a set value whereby a minimum power consumption value is obtained while maintaining comfort level index values in a plurality of spaces within a range that is considered as comfortable. Then, a set value is selected online from the optimum operation function by taking measurement values and set values from several kinds of sensors as input values, and an air conditioner is controlled based on the set value selected.

Patent Literature 2 discloses that by considering user attributes of spaces, target environmental conditions are set and controlled respectively for a plurality of spaces. In Patent Literature 2, it is aimed at preventing warming or cooling too much depending on the user attributes, and reducing power consumption.

### CITATION LIST

### Patent Literature

Patent Literature 1: JP 2011-27301 A

Patent Literature 2: JP 2011-153759 A

### SUMMARY OF INVENTION

### Technical Problem

Control over an air conditioning system may be adjusted when a user of a space feels uncomfortable due to an operation state of an air conditioner and influence of external environment, and when target power consumption is increased or reduced.

In these cases, by the technique disclosed in Patent Literature 1, it is necessary to regenerate an optimum operation function. By the technique disclosed in Patent Literature 2, it is necessary to suitably change conditions of external environment for a plurality of spaces respectively, and to adjust the power consumption to reach a target value. As described, it is troublesome to reconsider a relation between comfort levels in a plurality of spaces and the power consumption, and to reflect the relation to control over the air conditioning system.

The present invention is aimed at making it easier to adjust comfort levels in a plurality of spaces and power consumption.

### Solution to Problem

A control apparatus according to one aspect of the present invention includes:

a calculation unit to calculate a plurality of Pareto optimal solutions indicating a state wherein power consumption consumed by an air conditioning system including a plurality of air conditioners that are installed in a plurality of spaces is low, and wherein a comfort level of a user using each of the plurality of spaces is high, and to calculate a plurality of candidate values by taking, as a candidate value, a set value of the air conditioning system that becomes the state indicated by each of the plurality of Pareto optimal solutions calculated;

a selection unit to select, as a selection value, a candidate value from the plurality of candidate values calculated by the calculation unit; and

a control unit to control the air conditioning system with the selection value selected by the selection unit.

### Advantageous Effects of Invention

In the present invention, it is calculated a plurality of candidate values of set values whereby power consumption is low, and comfort levels in a plurality of spaces are respectively high. Therefore, it is possible to deal with a case of adjusting comfort levels in a plurality of spaces and power consumption by selecting another candidate value, and it is possible to make it easy to adjust the comfort levels in the plurality of spaces and the power consumption.

### BRIEF DESCRIPTION OF DRAWINGS

FIG. 1 is a configuration diagram of an air conditioning system 10 according to a first embodiment;

FIG. 2 is a configuration diagram of a control apparatus 20 according to the first embodiment;

FIG. 3 is a flowchart illustrating an operation of the control apparatus 20 according to the first embodiment;

FIG. 4 is an explanatory drawing of candidate value calculation according to the first embodiment;

FIG. 5 is an explanatory drawing of candidate value extraction according to the first embodiment;

FIG. 6 is a diagram illustrating a candidate value extracted according to the first embodiment;

FIG. 7 is a configuration diagram of the control apparatus 20 according to a third variation;

FIG. 8 is a configuration diagram of the control apparatus 20 according to a second embodiment;

FIG. 9 is an explanatory drawing of candidate value calculation according to the second embodiment;

FIG. 10 is a configuration diagram of an air conditioning system 10 according to a third embodiment;

FIG. 11 is a configuration diagram of the control apparatus 20 according to the third embodiment;

FIG. 12 is a flowchart illustrating an operation of the control apparatus 20 according to the third embodiment;

FIG. 13 is a configuration diagram of the air conditioning system 10 according to a fourth embodiment;

FIG. 14 is a configuration diagram of the control apparatus 20 according to the fourth embodiment; and

FIG. 15 is a flowchart illustrating an operation of the control apparatus 20 according to the fourth embodiment.

### DESCRIPTION OF EMBODIMENTS

### First Embodiment

### Explanation of Configuration

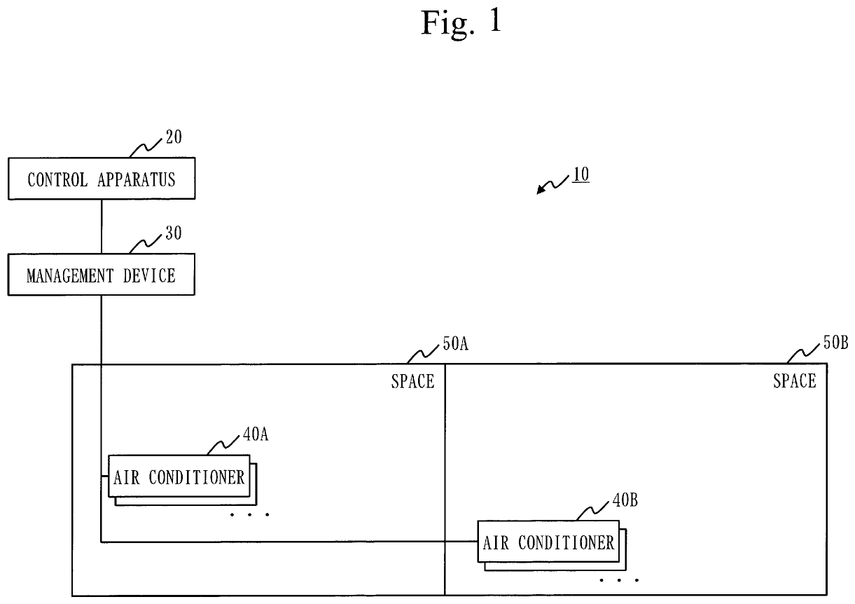

A configuration of an air conditioning system 10 according to a first embodiment will be described with reference to FIG. 1.

The air conditioning system 10 is equipped with a control apparatus 20, a management device 30, and air conditioners 40A and 40B.

The control apparatus 20 and the management device 30 are connected via a network. Further, the management device 30 and the air conditioners 40A and 40B are connected via a network.

The control apparatus 20 is a computer to control the air conditioning system 10. The management device 30 is a device to control the air conditioners 40A and 40B in accordance with control by the control apparatus 20. There may be a plurality of management devices 30, like a management device 30 for the air conditioner 40A and a management device 30 for the air conditioner 40B. The air conditioners 40A and 40B are devices to respectively realize air conditioning of spaces 50A and 50B, such as rooms to be used by users. The air conditioner 40A is installed in the space 50A, and the air conditioner 40B is installed in the space 50B.

In FIG. 1, indoor units installed inside the spaces 50A and 50B are illustrated as the air conditioners 40A and 50B for a descriptive purpose. However, the air conditioning system 10 also includes outdoor units to be installed outside the spaces 50A and 50B corresponding to respective outdoor units.

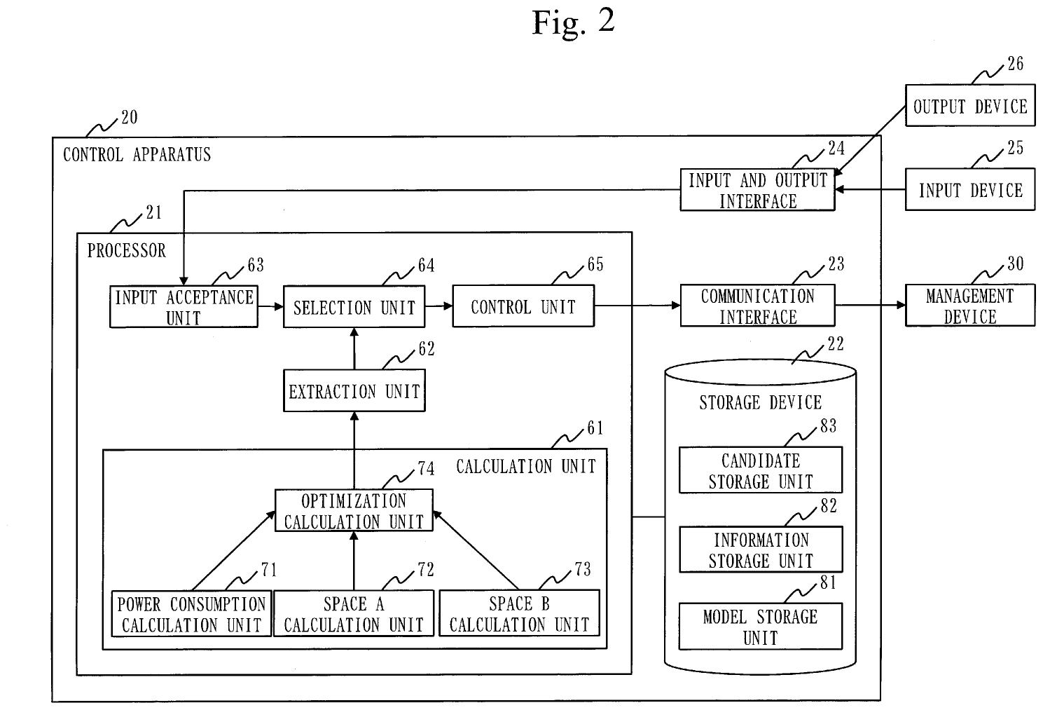

The configuration of the control apparatus 20 according to the first embodiment will be described with reference to FIG. 2.

The control apparatus 20 is equipped with hardware components such as a processor 21, a storage device 22, a communication interface 23 and an input and output interface 24. The processor 21 is connected to other hardware components via a signal line to control those other hardware components.

The processor 21 is an integrated circuit (IC) to perform processing. The processor 21 is, as a specific example, a central processing unit (CPU), digital signal processor (DSP) or a graphics processing unit (GPU).

The storage device 22 is, as a specific example, a random access memory (RAM), a read only memory (ROM), or a hard disk drive (HDD). Additionally, the storage device 22 may be a portable storage medium such as a secure digital (SD) memory card, a compact flash (CF),a NAND flash, a flexible disk, an optical disc, a compact disk, a Blue-ray (registered trademark) disc, a digital versatile disc (DVD), etc.

The communication interface 23 is a device to be connected to an external device, such as the management device 30. The communication interface 23 includes a transmitter to transmit information, and a receiver to receive information. The communication interface 23 is a network interface card (NIC), as a specific example.

The input and output interface 24 is a device whereto an input device 25 such as a keyboard or a mouse, and an output device 26 such as a display or a printer are connected. The input and output interface 24 is, as a specific example, a terminal of a universal serial bus (USB), an IEEE1394, a high-definition multimedia interface (HDMI (registered trademark)).

The control apparatus 20 is equipped with, as functional components, a calculation unit 61, an extraction unit 62, an input acceptance unit 63, a selection unit 64 and a control unit 65. The calculation unit 61 is equipped with a power consumption calculation unit 71, a space A calculation unit 72, a space B calculation unit 73 and an optimization calculation unit 74. Functions of respective units of the calculation unit 61, the extraction unit 62, the input acceptance unit 63, the selection unit 64, the control unit 65, the power consumption calculation unit 71, the space A calculation unit 72, the space B calculation unit 73 and the optimization calculation unit 74 are realized by software.

The storage device 22 stores programs to realize the functions of respective units of the control apparatus 20. These programs are read and executed by the processor 21. In this manner, the functions of respective units of the control apparatus 20 are realized. Further, the storage device 22 realizes a model storage unit 81, an information storage unit 82 and a candidate storage unit 83.

The information, data, signal values and variable values indicating results of processing by the functions of respective units realized by the processor 21 are stored in the storage device 22, a register or a cache memory in the processor 21. In the following explanation, it is described that the information, data, signal values and variable values indicating the results of the processing by the functions of respective units realized by the processor 21 are stored in the storage device 22.

It is assumed that the programs to realize respective functions realized by the processor 21 are stored in the storage device 22. However, the programs may be stored in a portable storage medium, such as a magnetic disk, a flexible disk, an optical disc, a compact disc, a Blue-ray (registered trademark) disc, a DVD, etc.

In FIG. 2, only one processor 21 is illustrated. However, there may be a plurality of processors 21, and the plurality of processors 21 may execute the programs to realize respective functions collaboratively.

### Explanation of Operation

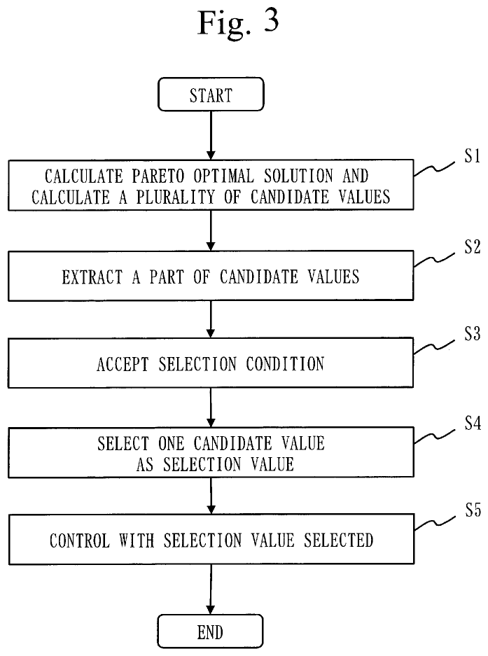

The operation of the control apparatus 20 according to the first embodiment will be described with reference to FIG. 3 through FIG. 6. The operation of the control apparatus 20 according to the first embodiment corresponds to a control method according to the first embodiment. Further, the operation of the control apparatus 20 according to the first embodiment corresponds to processing of a control program according to the first embodiment.

<Step S1 of FIG. 3: Calculation Processing>

The calculation unit 61 calculates a plurality of Pareto optimal solutions indicating states wherein power consumption consumed by the air conditioning system 10 is low, and comfort levels for users using the plurality of spaces 50A and 50B respectively are high. The Pareto optimal solutions are feasible solutions for a plurality of objective functions being competitive with each other. The calculation unit 61 calculates a plurality of candidate values by taking, as candidate values, set values of the air conditioning system 10 that becomes the states indicated respectively by the plurality of Pareto optimal solutions calculated.

The calculation unit 61 calculates a plurality of Pareto optimal solutions by performing a multi-objective optimization operation to optimize reduction of power consumption, improvement of the comfort level in the space 50A, and improvement of the comfort level in the space 50B. As the multi-objective optimization operation, an existing method such as Multi-objective Genetic Algorithm (MOGA) or Multi-objective Particle Swarm Optimization (MOPSO) is used. For calculation of a comfort level, an existing warm-cold sensitivity index such as Predicted Mean Vote (PMV), Standard new Effective Temperature (SET) or Universal Thermal Climate Index (UTCI) is used.

Specifically, the calculation unit 61 retrieves information stored in the model storage unit 81 and the information storage unit 82, and calculates a plurality of Pareto optimal solutions.

The model storage unit 81 stores information related to relations between users of the spaces 50A and 50B and the air conditioners 40A and 40B.

As a specific example, the model storage unit 81 stores information indicating an influence degree of an operation condition of the air conditioner 40A to users of the spaces 50A and 50B, such as when the air conditioner 40A is operated with a capacity X, a comfort level for the user of the space 50A is changed to a comfort level S, and a comfort level for the user of the space 50B is changed to a comfort level T.

The information storage unit 82 stores several types of information necessary for calculating a plurality of Pareto optimal solutions other than the information stored in the model storage unit 81.

As a specific example, the information storage unit 82 stores system configuration information of the air conditioners 40A and 40B, building information, outside air-temperature information, etc. The system configuration information of the air conditioners 40A and 40B includes information on a model, performance, age of service, etc. of the air conditioners 40A and 40B. Further, the system configuration information of the air conditioners 40A and 40B includes information indicating a connection relation between the air conditioners 40A and 40B, and the management device 30. Furthermore, the system configuration information of the air conditioners 40A and 40B includes information indicating a building as installation places and relation with the spaces 50A and 50B of the air conditioners 40A and 40B. The building information includes information on a position such as floor numbers and directions, sizes, shapes, and the number, directions and sizes of windows of, and a draft in the spaces 50A and 50B in the building. Further, the building information includes information on the overall building and use of the building such as a seat location of a user. The outside air-temperature information includes information on a value of an outside air-temperature being an actual measured value, or a predicted value as needed.

The power consumption calculation unit 71 of the calculation unit 61 retrieves information to be necessary for calculation of power consumption of the air conditioners 40A and 40B from the information storage unit 82, and calculates the power consumption of the air conditioners 40A and 40B. A space A calculation unit 72 of the calculation unit 61 retrieves information to be necessary for calculation of a comfort level in the space 50A from the information storage unit 82, and calculates the comfort level in the space 50A. Similarly, a space B calculation unit 73 of the calculation unit 61 retrieves information to be necessary for calculation of a comfort level in the space 50B from the information storage unit 82, and calculates the comfort level in the space 50B.

The optimization calculation unit 74 performs a multi-objective optimization operation by taking the power consumption, the comfort level in the space 50A and the comfort level in the space 50B calculated as input, and calculates a plurality of Pareto optimal solutions. The optimization calculation unit 74 calculates a plurality of candidate values by taking, as candidate values, set values of the air conditioning system 10 that becomes states respectively indicated by the plurality of Pareto optimal solutions calculated. The optimization calculation unit 74 writes the plurality of candidate values calculated into the candidate storage unit 83.

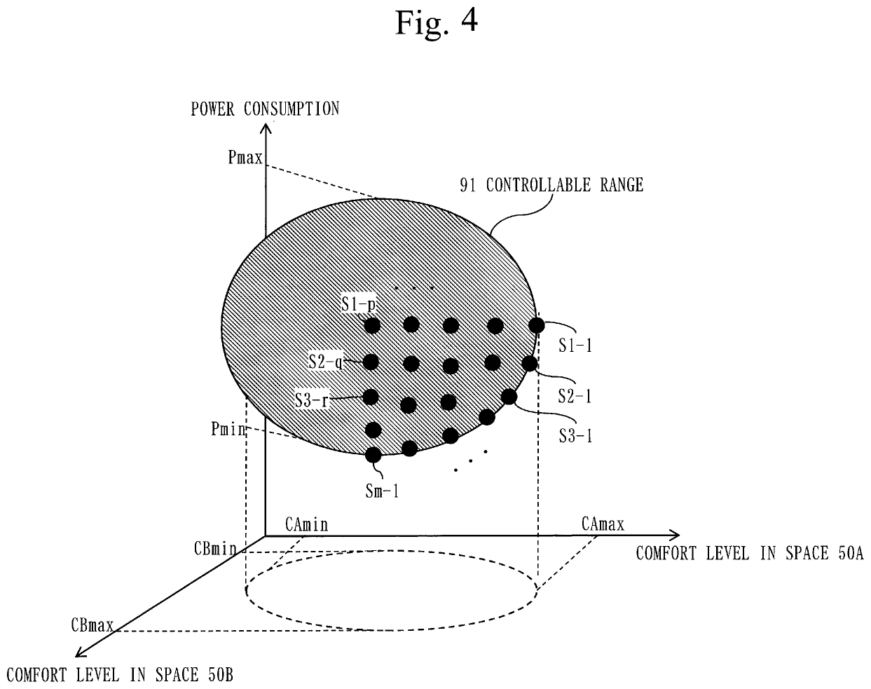

As illustrated in FIG. 4, by the system configuration, etc. of the air conditioners 40A and 40B, an upper limit Pmax and a lower limit Pmin of power consumption are determined Further, according to the fact that the upper and lower limits of the power consumption are determined, an upper limit CAmax and a lower limit CAmin of the comfort level in the space 50A, and an upper limit CBmax and a lower limit CBmin of the comfort level in the space 50B are determined. A controllable range 91 of air conditioning set based on the respective upper and lower limits Pmax, Pmin, CAmax, CAmin, CBmax and CBmin is determined.

The optimization calculation unit 74 calculates, in the controllable range 91, a plurality of Pareto optimal solutions of (1) a solution with a priority on the comfort level in the space 50A, (2) a solution with a priority on the comfort level in the space 50B, (3) a solution with a priority on power consumption, and (4) a solution whereby the comfort levels in the spaces 50A and 50B become high, and the power consumption becomes low in (1) through (3). Then, the optimization calculation unit 74 calculates set values S1-1 through S1-p, S2-1 through S2-q, . . . , Sm-1 to be the respective Pareto optimal solutions. The optimization calculation unit 74 writes to the candidate storage unit 83, as candidate values, the set values S1-1 through S1-p, S2-1 through S2-q, . . . , Sm-1 calculated.

The set values include a set temperature of the air conditioner 40A, an air volume of the air conditioner 40A, a set temperature of the air conditioner 40B and an air volume of the air conditioner 40B. Further, the set values include the power consumption, a comfort level in the space 50A and a comfort level in the space 50B in a case wherein control is carried out with the set values.

<Step S2 of FIG. 3: Extraction Processing>

The extraction unit 62 retrieves the plurality of candidate values calculated in the step S1 from the candidate storage unit 73. Then, the extraction unit 62 extracts a partial typical candidate value from the plurality of candidate values retrieved so that a manager of the air conditioning system 10 can easily make a selection.

Specifically, the extraction unit 62 extracts a partial candidate value from the plurality of candidate values retrieved in accordance with a restriction condition such as a target power consumption value, and a ratio between the space 50A and the space 50B. The extraction unit 62 writes the candidate value extracted into the candidate storage unit 83.

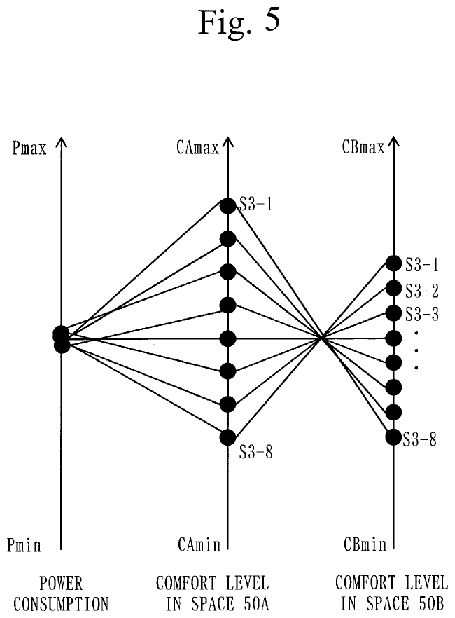

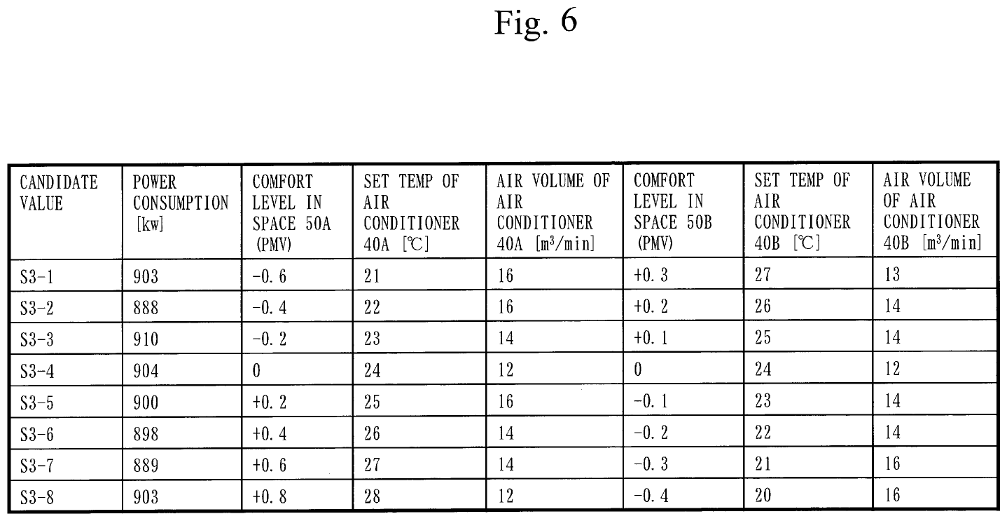

As a specific example, as illustrated in FIG. 5 and FIG. 6, when a target power consumption value is set as the restriction condition, the extraction unit 62 extracts candidate values having values close to the target power consumption value at regular intervals of comfort levels. Since there are many candidate values for which the ratios between the comfort levels of the space 50A and the space 50B are different even the power consumption values are the same, in FIG. 5 and FIG. 6, the comfort level in the space 50A is extracted at intervals of a PMV value of 0.2. As illustrated in FIG. 6, eight candidate values of candidate values S3-1 through S3-8 are extracted.

Further, as another specific example, when the ratio between the space 50A and the space 50B is set as the restriction condition, candidate values with the ratios of the comfort levels between the space 50A and the space 50B being close to a condition set beforehand are extracted at regular intervals of power consumption values.

<Step S3 of FIG. 3: Input Acceptance Processing>

The input acceptance unit 63 accepts input of selection conditions to select a candidate value from the manager.

Specifically, the input acceptance unit 63 displays selection conditions whereby one candidate value can be specified on a display device being the output device 26. Then, the input acceptance unit 63 makes the manager select a desired selection condition from the selection conditions displayed.

The selection conditions are, as specific examples, “(A) suppress the comfort level in each space 50 within a fixed range, and reduce the power consumption to a fixed value or lower for energy saving operation” and “(B) improve the comfort level in each space 50 as much as possible within a range of a certain target value of power consumption, and make the PMV value of the space 50A 0.3 higher than that of the space 50B since there is a surplus of electric power.” Here, as the selection condition (A), when a selection condition which additionally requires data setting of a fixed range or a fixed value is selected, the input acceptance unit 63 accepts input of additional data from the manager.

<Step S4 of FIG. 3: Selection Processing>

The selection unit 64 selects, as a selection value, a candidate value in accordance with the selection conditions accepted in the step S3 from the plurality of candidate values extracted in the step S2.

As a specific example, when the condition (B) is accepted in the step S3, and 900 kW is set as the target value of power consumption, a candidate value S3-5 whereby the PMV value in the space 50A is 0.3 higher than that in the space 50B in the candidate values of FIG. 6.

<Step S5 of FIG. 3: Control Processing>

The control unit 65 makes the management device 30 control the air conditioners 40A and 40B in the air conditioning system 10 by the selection value selected in the step S4.

Specifically, the control unit 65 transmits a set temperature of the air conditioner 40A, an air volume of the air conditioner 40A, a set temperature of the air conditioner 40B and an air volume of the air conditioner 40B indicated by the selection value, to the management device 30 via the communication interface 23. The management device 30 controls the air conditioner 40A in accordance with the set temperature of the air conditioner 40A and the air volume of the air conditioner 40A, and controls the air conditioner 40B in accordance with the set temperature of the air conditioner 40B and the air volume of the air conditioner 40B.

Accordingly, the air conditioning system 10 is controlled in a state of being matched to the selection condition accepted in the step S3, and each space 50 is put into a comfort level specified by the manager.

### Effect of First Embodiment

As described above, the control apparatus 20 according to the first embodiment calculates a plurality of set values whereby power consumption is low, and respective comfort levels in a plurality of spaces are high are calculated. Then, by selecting a set value in accordance with a selection condition input, control is performed with the set value selected.

Therefore, in a case wherein comfort levels in a plurality of spaces and power consumption are adjusted, the case can be dealt with by inputting a selection condition again, and selecting another candidate value, and it is possible to easily adjust comfort levels in a plurality of spaces and power consumption.

That is, in a case wherein it is desired to change power consumption, or to improve a comfort level more when the air conditioners 40A and 40B are controlled based on a candidate value once selected in the step S5, processing is returned to the step S3 again, and input of selection conditions is accepted. That is, in this case, there is no need to recalculate a plurality of Pareto optimal solutions in the step S1 again.

### Other Configurations

<First Variation>

In the first embodiment, in the step S3, the input acceptance unit 63 accepts input of a selection condition. However, as a variation, in the step S3, the input acceptance unit 63 may accept input of a candidate values to select.

In this case, the input acceptance unit 63 displays on the display device being the output device 26 a list of candidate values extracted in the step S2. That is, the input acceptance unit 63 displays on the display device the list as illustrated in FIG. 6. Then, the input acceptance unit 63 makes a candidate value be selected from the list displayed. In the step S4, the selection unit 64 takes the candidate value selected in the step S3 as a selection value.

<Second Variation>

In the first embodiment, the storage device 22 realizes the model storage unit 81 and the information storage unit 82. However, as a second variation, the model storage unit 81 and the information storage unit 82 may be realized by an external device different from the control apparatus 20. In this case, the calculation unit 61 has only to retrieve information stored in the model storage unit 81 and the information storage unit 82 from the external device via the communication interface 23.

<Third Variation>

In the first embodiment, the functions of respective units in the control apparatus 20 are realized by software. However, as a third variation, the functions of respective units in the control apparatus 20 may be realized by hardware. Regarding the third variation, parts different from those in the first embodiment will be described.

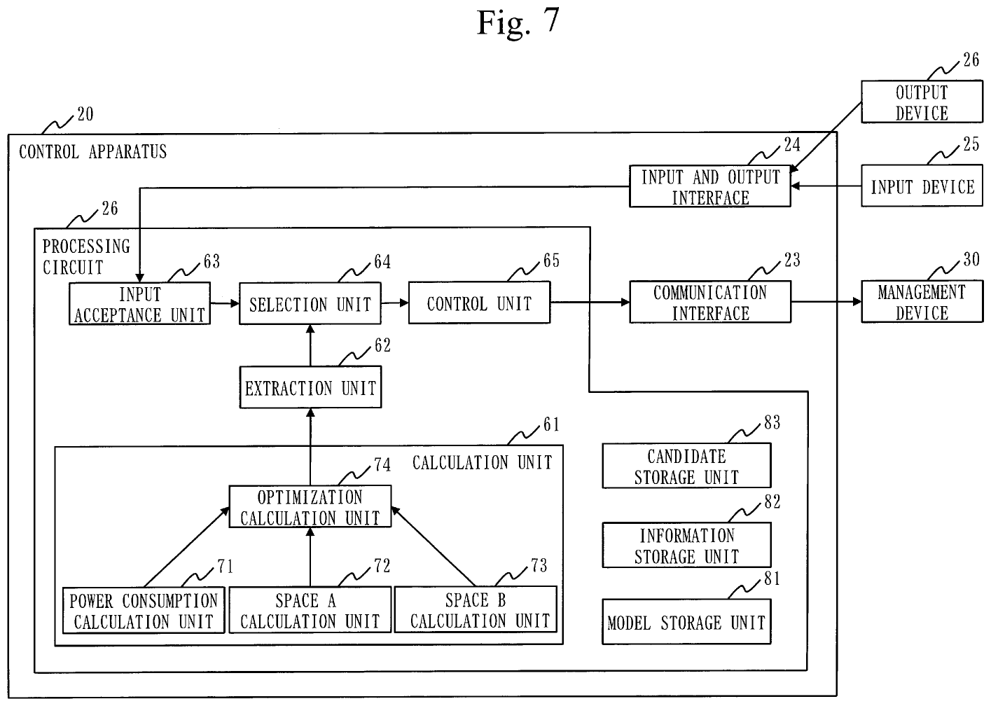

The configuration of the control apparatus 20 according to the third variation will be described with reference to FIG. 7.

In a case wherein the functions of respective units are realized by hardware, the control apparatus 20 is equipped with a processing circuit 27 in place of the processor 21 and the storage device 22. The processing circuit 27 is a dedicated electronic circuit to realize the functions of the respective units of the control apparatus 20 and the functions of the storage device 22.

As the processing circuit 27, a single circuit, a composite circuit, a programmed processor, a parallel programmed processor that is made into a parallel program, a logic IC, a gate array (GA), an application specific integrated circuit (ASIC), or a field-programmable gate array (FPGA) is supposed.

The functions of the respective units may be realized by one processing circuit 27, or may be realized by a plurality of processing circuits 27 in a distributed manner.

<Fourth Variation>

As a fourth variation, a part of the functions may be realized by hardware, and the other functions may be realized by software. That is, of the respective units in the control apparatus 20, a part of the functions may be realized by hardware, and the other functions may be realized by software.

The processor 21, the storage device 22 and the processing circuit 27 are collectively referred to as “processing circuitry.” That is, the functions of the respective units are realized by the processing circuitry.

### Second Embodiment

A second embodiment is different from the first embodiment in that the calculation unit 61 limits a range to calculate as candidate values. In the second embodiment, this different part will be described.

### Explanation of Configuration

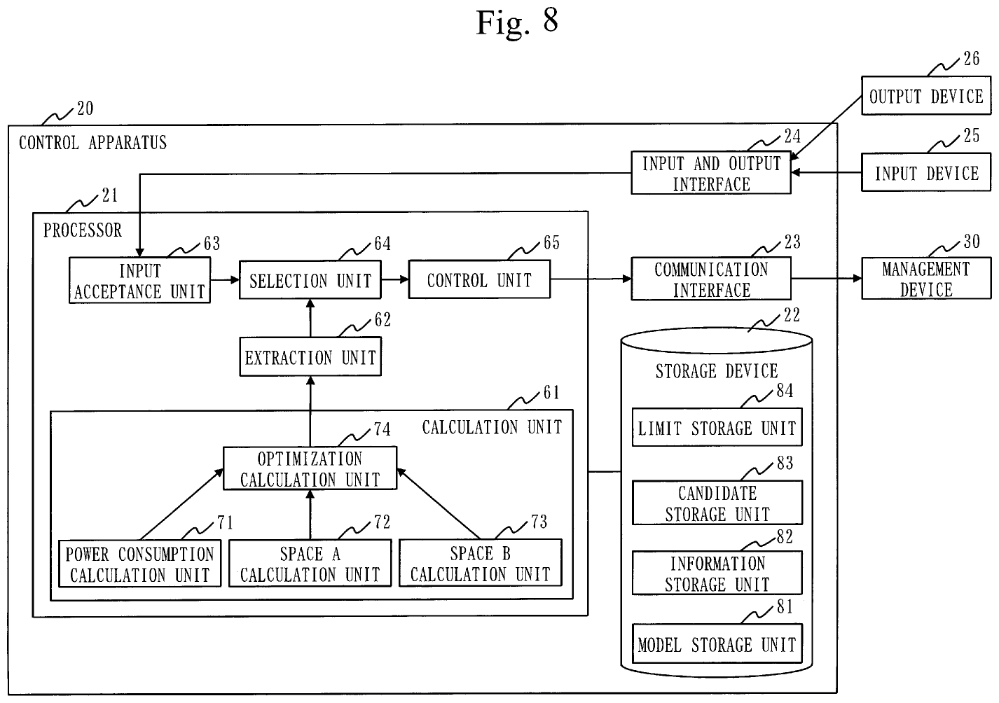

A configuration of a control apparatus 20 according to the second embodiment will be described with reference to FIG. 8.

The control apparatus 20 is different from the control apparatus 20 as illustrated in FIG. 2 in that the storage device 22 realizes a limit storage unit 84.

The limit storage unit 84 stores limit information to limit a range of at least any one item of power consumption and comfort levels. The limit storage unit 84 stores, as a specific example, limit information indicating that power consumption is limited to Rmax or lower.

### Explanation of Operation

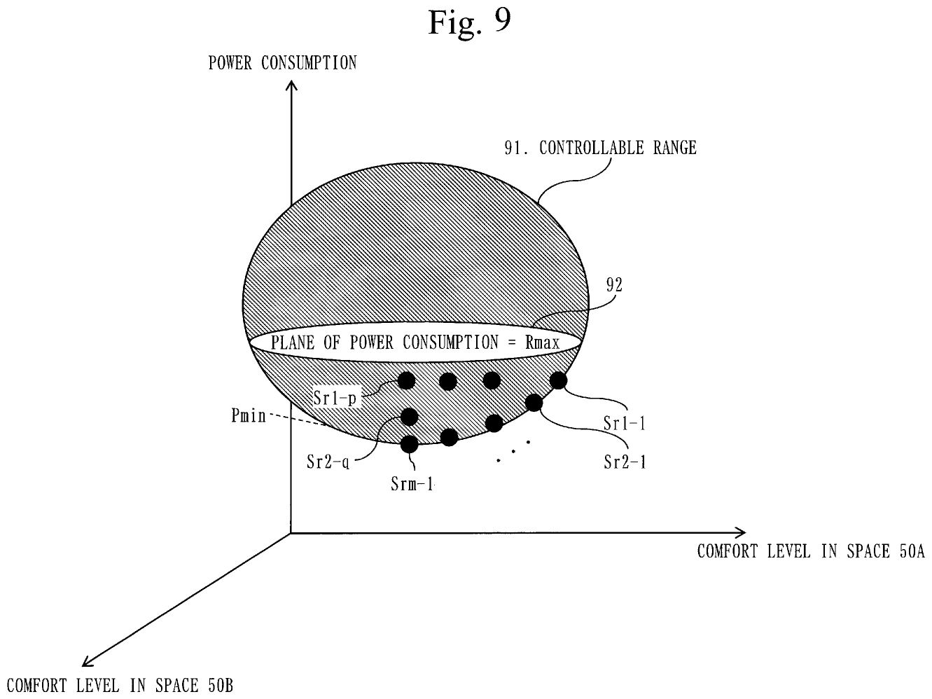

The operation of the control apparatus 20 according to the second embodiment will be described with reference to FIG. 3 and FIG. 9.

The operation of the control apparatus 20 according to the second embodiment corresponds to a control method according to the second embodiment. Further, the operation of the control apparatus 20 according to the second embodiment corresponds to processing of a control program according to the second embodiment.

Processing from a step S2 through a step S5 is the same as that in the first embodiment.

<Step S1 of FIG. 3: Calculation Processing>

The calculation unit 61 calculates a plurality of Pareto optimal solutions as with the first embodiment. The calculation unit 61 retrieves the limit information stored in the limit storage unit 84, and specifies Pareto optimal solutions whereby items of power consumption and a comfort level fall within a range limited by the limit information retrieved, of the plurality of Pareto optimal solutions calculated. Then, the calculation unit 61 takes, as candidate values, set values of the air conditioning system 10 that becomes states indicated by the Pareto optimal solutions specified.

As a specific example, in a case wherein the limit information indicates that power consumption should be Rmax or lower, the calculation unit 61 specifies Pareto optimal solutions whereby power consumption becomes Rmax or lower, of the plurality of Pareto optimal solutions calculated. That is, as illustrated in FIG. 9, when a plane 92 is assumed to be a plane of power consumption being Rmax, the calculation unit 61 specifies Pareto optimal solutions located in or lower than the plane 92. Then, the calculation unit 61 takes, as candidate values, setting values Sr1-1, . . . , Sr1-p, Sr2-1, Sr2-q, . . . , Srm-1 of the air conditioning system 10 that becomes the states indicated by the Pareto optimal solutions specified.

### Effect of Second Embodiment

As described above, the control apparatus 20 according to the second embodiment limits a range to be calculated by the calculation unit 61 as candidate values by limit information. Accordingly, it is possible to make set values which are not to be selected not be calculated as candidate values, and not be selected as a selection value.

### Third Embodiment

A third embodiment is different from the first and second embodiments in that candidate values are selected based on air environment where users using the spaces 50A and 50B feel comfortable. In the third embodiment, this different part will be described.

In the third embodiment, explanation is provided of a case wherein functions are added to the first embodiment; however, it is also possible to add functions to the second embodiment.

### Explanation of Configuration

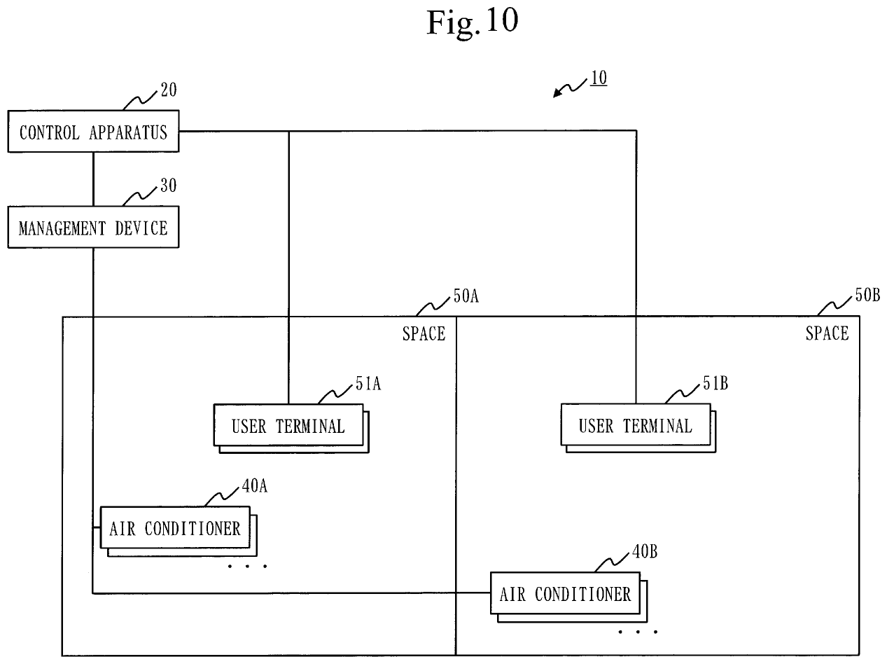

A configuration of an air conditioning system 10 according to the third embodiment will be described with reference to FIG. 10

The air conditioning system 10 is different from the air conditioning system 10 illustrated in FIG. 1 in that it includes user terminals 51A and 51B.

The user terminals 51A and 51B are computers such as personal computers (PCs) used by users. In FIG. 10, the user terminal 51A is installed in the space 50A, and the user terminal 51B is installed in the space 51B. However, the installation places are not limited to this, and the user terminals 51 may be installed in other places.

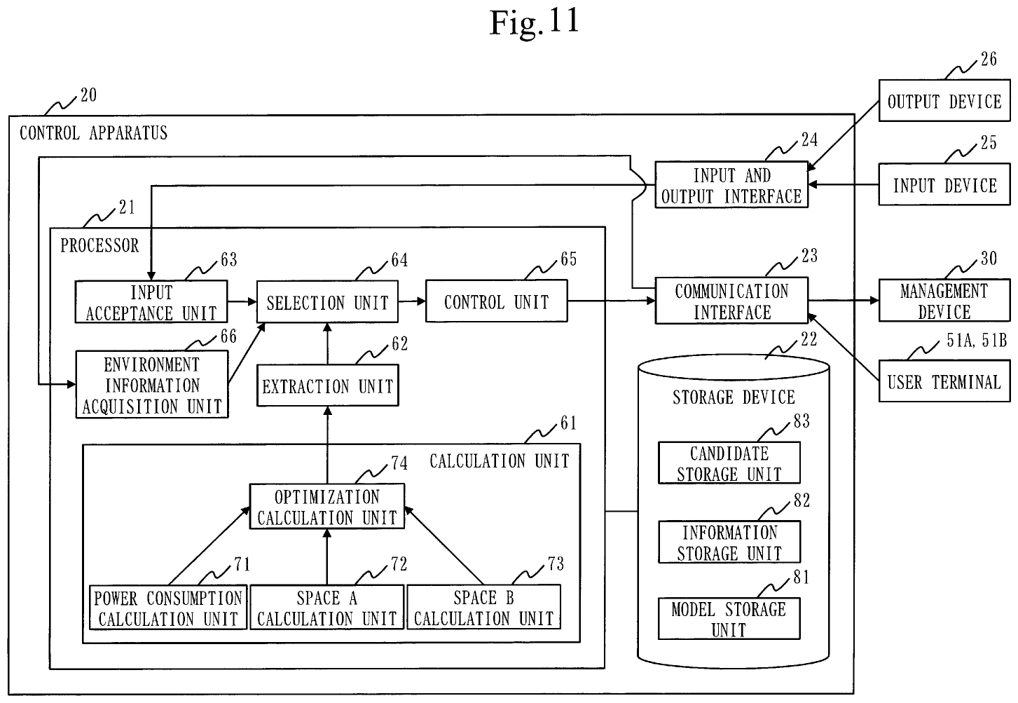

The configuration of the control apparatus 20 according to the third embodiment will be described with reference to FIG. 11.

The control apparatus 20 is different from the control apparatus 20 illustrated in FIG. 2 in that it includes an environment information acquisition unit 66.

The environment information acquisition unit 66 acquires environment information indicating air environment where users using the spaces 50A and 50B feel comfortable.

The environment information is information indicating that a user is sensitive to heat or sensitive to cold. The environment information is at least any of information on a space such as temperature, humidity, wind velocity, radiation, etc. where a user feels comfortable, and information on a state of a user such as a metabolic rate, an amount of clothing, etc.

### Explanation of Operation

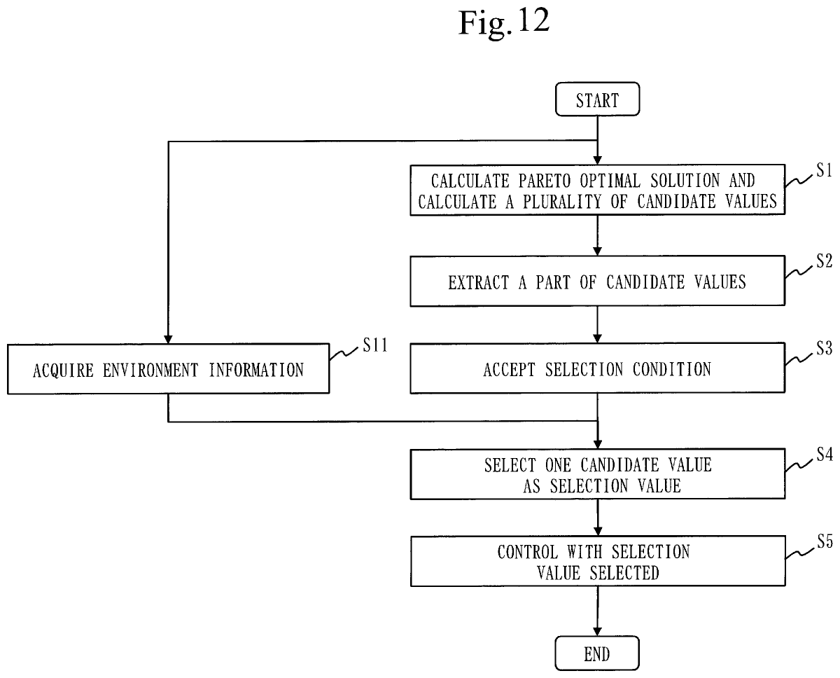

The operation of the control apparatus 20 according to the third embodiment will be described with reference to FIG. 12.

The operation of the control apparatus 20 according to the third embodiment corresponds to a control method according to the third embodiment. Further, the operation of the control apparatus 20 according to the third embodiment corresponds to processing of a control program according to the third embodiment.

Processing of a step S1 through a step S3, and a step S5 is the same as that in the first embodiment.

<Step S11 of FIG. 12: Environment Information Acquisition Processing>

The environment information acquisition unit 66 acquires environment information on a user of the space 50A from the user terminal 51A, and acquires environment information on a user of the space 50B from the user terminal 51B.

Processing of a step S11 may be performed separately from the processing of the step S1 through the step S5. As a specific example, only the processing of the step S11 may be performed, and the environment information may be collected in advance.

<Step S4 of FIG. 12: Selection Processing>

The selection unit 64 selects a candidate values as a selection value in accordance with the selection conditions accepted in the step S3, and environment information acquired in the step S11.

Specifically, the selection unit 64 updates comfort levels in the space 50A stored in the candidate storage unit 83 based on the environment information with respect to users in the space 50A, and updates comfort levels in the space 50B stored in the candidate storage unit 83 based on the environment information with respect to users in the space 50B. As a specific example, in a case wherein there are more people who are sensitive to heat than people who are sensitive to cold in the users in the space 50A, the selection unit 64 updates the comfort levels in the space 50A in the candidate values stored in the candidate storage unit 83 based on a recognition that the comfort level is higher when the temperature in the space 50A is lower. For example, 0.2 is added respectively to values of comfort levels (PMV) in the space 50A of FIG. 6. Then, the selection unit 64 selects a candidate value as a selection value using the comfort levels updated, in a manner similar to that in the first embodiment.

### Effect of Third Embodiment

As described above, the control apparatus 20 according to the third embodiment selects candidate values using environment information. There is a case wherein existing warm-cold sensitivity indexes are not indexes based on a personal sense of a user, being different from a comfort level that an actual user feels. However, the control apparatus 20 according to the third embodiment selects candidate values using environment information indicating air environment where a user feels comfortable based on a personal feeling of the user. Accordingly, it is possible to control the air conditioning system 10 using a more suitable set value, and improve the comfort level of users.

### Fourth Embodiment

A fourth embodiment is different from the first through third embodiments in that candidate values are selected by specifying users in the spaces 50A and 50B. This different point will be described in the fourth embodiment.

In the fourth embodiment, explanation is provided of a case wherein functions are added to the first embodiment; however, it is also possible to add functions to the second or third embodiment.

### Explanation of Configuration

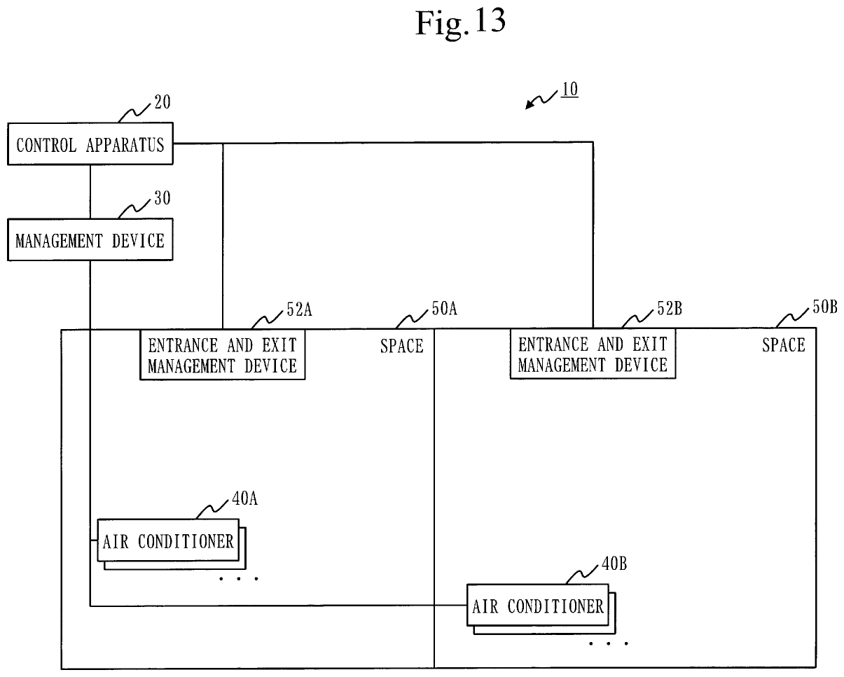

A configuration of an air conditioning system 10 according to the fourth embodiment will be described with reference to FIG. 13.

The air conditioning system 10 is different from the air conditioning system 10 indicated in FIG. 1 in that it includes entrance and exit management devices 52A and 52B.

The entrance and exit management devices 52A and 52B are devices to manage entrance and exit of users into and from the spaces 50A and 50B. As a specific example, the entrance and exit management devices 52A and 52B are devices installed in doorways of the spaces 50A and 50B to retrieve and manage identification information of the users when the users enter into and exit from the spaces 50A and 50B.

In FIG. 13, each one piece of the entrance and exit management devices 52A and 52B is indicated, respectively; however, a plurality of pieces of the entrance and exit management devices 52A and 52B may be installed, respectively.

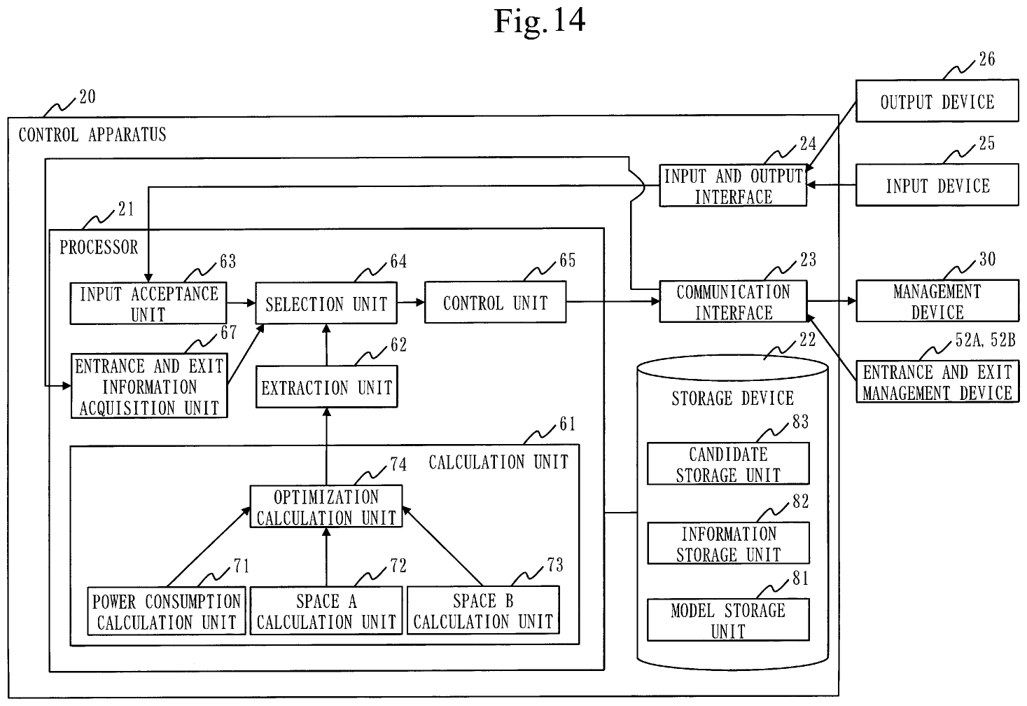

A configuration of the control apparatus 20 according to the fourth embodiment will be described with reference to FIG. 14.

The control apparatus 20 is different from the control apparatus 20 indicated in FIG. 2 in that it includes an entrance and exit information acquisition unit 67.

The entrance and exit information acquisition unit 67 acquires entrance and exit information of users regarding the spaces 50A and 50B respectively from the entrance and exit management devices 52A and 52B.

### Explanation of Operation

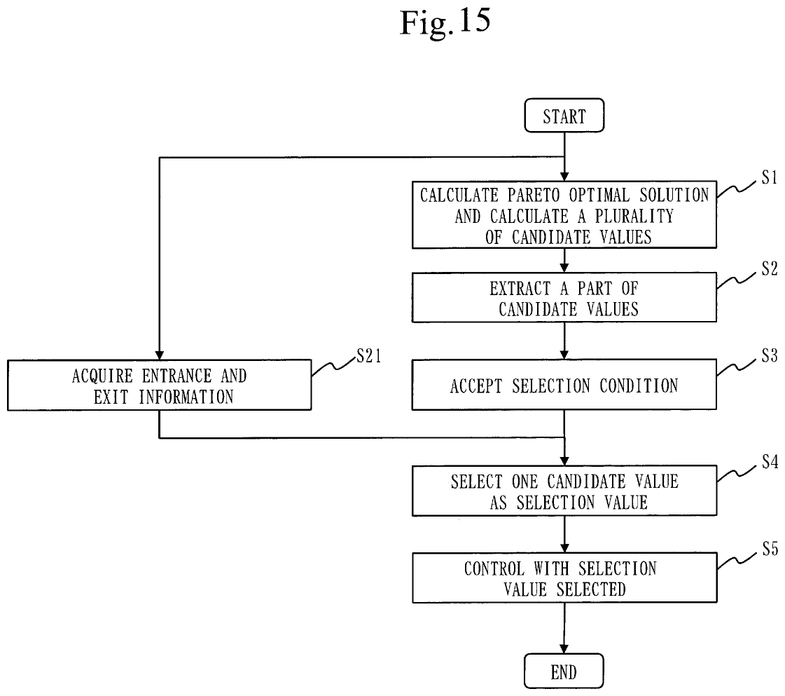

The operation of the control apparatus 20 according to the fourth embodiment will be described with reference to FIG. 15.

The operation of the control apparatus 20 according to the fourth embodiment corresponds to a control method according to the fourth embodiment. Further, the operation of the control apparatus 20 according to the fourth embodiment corresponds to processing of a control program according to the fourth embodiment.

Processing of a step S1 through a step S3, and a step S5 is the same as those in the first embodiment.

<Step S21 of FIG. 15: Environment Information Acquisition Processing>

The entrance and exit information acquisition unit 67 acquires entrance and exit information regarding the space 50A from the entrance and exit management device 52A, and acquires entrance and exit information regarding the space 50B from the entrance and exit management device 52B.

<Step S4 in FIG. 15: Selection Processing>

The selection unit 64 selects, as a selection value, a candidate value in accordance with the selection conditions accepted in the step S3, and the entrance and exit information acquired in the step S21, from the plurality of candidate values extracted in the step S2.

Specifically, the selection unit 64 specifies the number of people existing in the space 50A based on the entrance and exit information regarding the space 50A, and specifies the number of people existing in the space 50B based on the entrance and exit information regarding the space 50B. Then, the selection unit 64 updates comfort levels in the space 50A stored in the candidate storage unit 83 based on the number of people in the space 50A, and updates comfort levels in the space 50B stored in the candidate storage unit 83 based on the number of people in the space 50B. As a specific example, when there are many people in a same space, heat production is high; hence, in a case wherein the number of people existing in the space 50A is equal to or more than a standard number of people, the comfort levels in the space 50A in the candidate values stored in the candidate storage unit 83 are updated based on a recognition that the comfort level is higher when the temperature in the space 50A is lower. Then, the selection unit 64 selects, as a selection value, a candidate value using the comfort levels updated in a method similar to that in the first embodiment.

### Effect of Fourth Embodiment

As described above, the control apparatus 20 according to the fourth embodiment specifies the number of people existing in the space 50, and selects candidate values using the number of people specified. Accordingly, it is possible to control the air conditioning system 10 using a more suitable set value, and improve the comfort level of users.

### Other Configurations

<Fifth Variation>

In the fourth embodiment, explanation is provided of the case wherein the functions are added to the first embodiment. However, as a fifth variation, the functions may be added to the third embodiment. In this case, the selection unit 64 specifies users existing in the space 50 based on the entrance and exit information acquired in the step S21. Then, from the environment information acquired in the step S11, the selection unit 64 extracts environment information regarding the users specified, and selects candidate values using the environment information extracted. That is, without considering environment information of a user who does not exist in the space 50, the candidate values are selected in consideration of the environment information of the users existing in the space 50.

Accordingly, it is possible to control the air conditioning system 10 using more suitable set values, and improve the comfort level of users.

<Sixth Variation>

In the fourth embodiment, the number of people existing in the space 50 is specified, and candidate values are selected using the number of people specified. However, as a sixth variation, it may be applicable to specify users existing in the space 50, and perform more delicate control by using seat locations of the users specified. As a specific example, air volumes of a plurality of air conditioners 40A may be respectively set according to the seat locations of the users in the space 50A.

<Seventh Variation>

In the second through fourth embodiments, the functions of the respective units in the control apparatus 20 are realized by software, as with the first embodiment. However, the functions of the respective units in the control apparatus 20 may be realized by hardware, as with the third variation. Further, in the control apparatus 20, a part of the functions may be realized by hardware, and the other functions may be realized by software, as with the fourth variation.

The above describes the embodiments and the variations of the present invention; however, more than one of those embodiments and variations may be combined and implemented. Otherwise, any one of or some of those embodiments and variations may be partially implemented. Note that the present invention is not limited to the embodiments and the variations as described above, and various alterations can be made as needed.

### REFERENCE SIGNS LIST

10: air conditioning system; 20: control apparatus; 21: processor; 22: storage device; 23: communication interface; 24: input and output interface; 25: input device; 26: output device; 27: processing circuit; 30: management device; 40: air conditioner; 50: space; 51: user terminal; 52: entrance and exit management device; 61: calculation unit; 62: extraction unit; 63: input acceptance unit; 64: selection unit; 65: control unit; 66: environment information acquisition unit; 67: entrance and exit information acquisition unit; 71: power consumption calculation unit; 72: space A calculation unit; 73: space B calculation unit; 74: optimization calculation unit; 81: model storage unit; 82: information storage unit; 83: candidate storage unit; 84: limit storage unit; 91: controllable range; 92: plane

1-7. (canceled)

8. A control apparatus comprising:
processing circuitry to:
calculate a plurality of Pareto optimal solutions indicating a state wherein power consumption consumed by an air conditioning system including a plurality of air conditioners that are installed in a plurality of spaces is low, and wherein a comfort level of a user using each of the plurality of spaces is high, and to calculate a plurality of candidate values by taking, as a candidate value, a set value of the air conditioning system that becomes the state indicated by each of the plurality of Pareto optimal solutions calculated;
select, as a selection value, a candidate value from the plurality of calculated candidate values, in accordance with the number of users existing in each of the plurality of spaces; and
control the air conditioning system with the selected selection value.

9. The control apparatus as defined in claim 8,
wherein the processing circuitry accepts an input from a manager, and
selects the candidate value in accordance with the accepted input.

10. The control apparatus as defined in claim 9,
wherein the processing circuitry accepts an input of a selection condition to select the candidate value,
and selects the candidate value in accordance with the selection condition.

11. The control apparatus as defined in claim 8,
wherein the processing circuitry takes, as a candidate value, a set value of the air conditioning system to become a state indicated by a Pareto optimal solution whereby, within a range limited by a limit condition to limit a range of at least one item of the power consumption and the comfort level, the at least one item falls.

12. The control apparatus as defined in claim 9,
wherein the processing circuitry takes, as a candidate value, a set value of the air conditioning system to become a state indicated by a Pareto optimal solution whereby, within a range limited by a limit condition to limit a range of at least one item of the power consumption and the comfort level, the at least one item falls.

13. The control apparatus as defined in claim 10,
wherein the processing circuitry takes, as a candidate value, a set value of the air conditioning system to become a state indicated by a Pareto optimal solution whereby, within a range limited by a limit condition to limit a range of at least one item of the power consumption and the comfort level, the at least one item falls.

14. The control apparatus as defined in claim 8,
wherein the processing circuitry selects the candidate value in accordance with environment information indicating air environment where the user using each of the plurality of spaces feels comfortable.

15. The control apparatus as defined in claim 9,
wherein the processing circuitry selects the candidate value in accordance with environment information indicating air environment where the user using each of the plurality of spaces feels comfortable.

16. The control apparatus as defined in claim 10,
wherein the processing circuitry selects the candidate value in accordance with environment information indicating air environment where the user using each of the plurality of spaces feels comfortable.

17. The control apparatus as defined in claim 11,
wherein the processing circuitry selects the candidate value in accordance with environment information indicating air environment where the user using each of the plurality of spaces feels comfortable.

18. The control apparatus as defined in claim 12,
wherein the processing circuitry selects the candidate value in accordance with environment information indicating air environment where the user using each of the plurality of spaces feels comfortable.

19. The control apparatus as defined in claim 13,
wherein the processing circuitry selects the candidate value in accordance with environment information indicating air environment where the user using each of the plurality of spaces feels comfortable.

20. A non-transitory computer readable medium storing a control program to make a computer execute:
a calculation process to calculate a plurality of Pareto optimal solutions indicating a state wherein power consumption consumed by an air conditioning system including a plurality of air conditioners that are installed in a plurality of spaces is low, and wherein a comfort level of a user using each of the plurality of spaces is high, and to calculate a plurality of candidate values by taking, as a candidate value, a set value of the air conditioning system that becomes the state indicated by each of the plurality of Pareto optimal solutions calculated;
a selection process to select, as a selection value, a candidate value from the plurality of candidate values calculated by the calculation process, in accordance with the number of users existing in each of the plurality of spaces; and
a control process to control the air conditioning system with the selection value selected by the selection process.
